(19) United States
(12) Patent Application Publication
(10) Pub. No.: US 2026/0086398 A1
(43) Pub. Date: Mar. 26, 2026

(54) OPTICAL MODULATOR AND OPTICAL TRANSMISSION SYSTEM BASED ON DUAL PARALLEL MODULATION ARCHITECTURE

(71) Applicant: Global Technology Inc., Ningbo (CN)

(72) Inventors: Weikang KE, Ningbo (CN); Fan YANG, Ningbo (CN); Qikun Huang, Ningbo (CN)

(21) Appl. No.: 18/976,602

(22) Filed: Dec. 11, 2024

(30) Foreign Application Priority Data
Sep. 24, 2024 (CN) 202411336642.9

(51) Int. Cl. G02F 1/035; G02F 1/21

(52) U.S. Cl. CPC G02F 1/0356; G02F 1/212; G02F 2202/20

(57) ABSTRACT

An optical modulator and optical transmission system. The optical modulator includes a first/second optical waveguide, a first thermal electrode, two radio frequency signal channels and two ground channels. Each of the first and second optical waveguides includes an input section, a pre-modulation section and a post-modulation section, the pre-modulation section includes two branches, the first input section is optically coupled to the second input section, and the first post-modulation section is optically coupled to a second post-modulation section. The first thermal electrode is disposed at one of the two first branches. The two radio frequency signal channels are disposed at one side of the first post-modulation section and one side of the second post-modulation section, respectively. The two ground channels are disposed at the other side of the first post-modulation section and the other side of the second post-modulation section, respectively.

### CROSS-REFERENCE TO RELATED APPLICATIONS

This non-provisional application claims priority under 35 U.S.C. § 119(a) on Patent Application No(s). 202411336642.9 filed in China on September, 24, 2024, the entire contents of which are hereby incorporated by reference.

### BACKGROUND

### 1. Technical Field

This disclosure relates to an optical modulator and an optical transmission system.

### 2. Related Art

The optical module may transmit and/or receive optical signals for applications such as but not limited to the network data center, the cable TV and the fiber to the home (FTTH). Using optical modules for transmission may provide higher transmission rates and signal bandwidth over longer transmission distances. In order to promote the compatibility of global optical Internet products and reduce the maintenance burden, organizations such as the Multi-Source Agreement (MSA), the Institute of Electrical and Electronics Engineers (IEEE), and the Optical Internetworking Forum (OIF) have developed several form factors (Form Factor) suitable for different signal transmission rates. These form factors include but are not limited to XFP, SFP, QSFP (Quad Small Form Factor Pluggable), QSFP-DD (Double Density), OSFP (Octal Small Form Factor Pluggable) and CPO (Co-Packaged Optics).

Existing optical modules faces challenges in optical power, space management, thermal management, insertion loss and manufacturing yield.

### SUMMARY

According to one or more embodiment of this disclosure, an optical modulator includes a first optical waveguide, a second optical waveguide, a first thermal electrode, two radio frequency signal channels and two ground channels. The first optical waveguide includes a first input section, a first pre-modulation section and a first post-modulation section, and the first pre-modulation section includes two first branches. The second optical waveguide includes a second input section, a second pre-modulation section and a second post-modulation section, and the second pre-modulation section includes two second branches. The first input section is optically coupled to the second input section, and the first post-modulation section is optically coupled to the second post-modulation section. The first thermal electrode is disposed at one of the two first branches. The two radio frequency signal channels are disposed at one side of the first post-modulation section and one side of the second post-modulation section, respectively. The two ground channels are disposed at the other side of the first post-modulation section and the other side of the second post-modulation section, respectively.

According to one or more embodiment of this disclosure, an optical transmission system includes a laser light source, an optical modulator and a driving circuit. The laser light source is configured to output an initial optical signal. The optical modulator includes a first optical waveguide, a second optical waveguide, a first thermal electrode, two radio frequency signal channels and two ground channels. The first optical waveguide includes a first input section, a first pre-modulation section and a first post-modulation section, and the first pre-modulation section includes two first branches. The second optical waveguide includes a second input section, a second pre-modulation section and a second post-modulation section, and the second pre-modulation section includes two second branches. The first input section is optically coupled to the second input section, and the first post-modulation section is optically coupled to the second post-modulation section. The first thermal electrode is disposed at one of the two first branches. The two radio frequency signal channels are disposed at one side of the first post-modulation section and one side of the second post-modulation section, respectively. The two ground channels are disposed at the other side of the first post-modulation section and the other side of the second post-modulation section, respectively. The driving circuit is electrically connected to the two radio frequency signal channels, and the driving circuit is configured to provide two differential signals to the two radio frequency signal channels.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 shows an optical modulator based on a dual parallel modulation architecture according to an embodiment of the present disclosure; and

FIG. 2 shows an optical transmission system based on a dual parallel modulation architecture according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

With the rapid development of optical communication technology, the requirements for modulation accuracy, transmission distance and transmission rate of optical signals have become increasingly higher. For long-distance transmission application, the dispersion plays critical role in limiting the transmission distance. In application scenarios such as transmission rates above 25G or transmission distances above 40 kilometers, this issue needs to be addressed. Therefore, how to compensate for dispersion is an important issue in long-distance transmission, and chirp control is one of the important compensation methods.

An optical modulator known to the applicant often faces problems such as low modulation efficiency and difficulty in chirp control when dealing with complex and unpredictable transmission environments. The dual-parallel Mach-Zehnder modulator (DPMZM) structure has become an important means to achieve complex modulation formats and chirp control because it may simultaneously control the amplitude and phase of the signal.

In view of the above description, the optical modulator and the optical transmission system of the present disclosure are configured such that a thermal electrode is disposed at a branch of a pre-modulation section, and a radio frequency signal channel is disposed at a post-modulation section of two optical waveguides. In this way, the phase of the optical signal of the pre-modulation section may be changed by controlling the DC voltage applied to the thermal electrode, to change the output optical power of two branches and achieve the dispersion compensation of the first stage; and the output amplitude of the optical signal may be changed by controlling the differential signal applied to the radio frequency signal channel in the post-modulation section and achieve the dispersion compensation of the second stage. This enables the overall optical modulator and optical transmission system to have a longer transmission distance, and is especially applicable for long-distance, high-speed optical fiber communication systems.

Those with ordinary knowledge in the art may reasonably combine and configure the technical features disclosed herein to achieve corresponding technical effects.

The term “coupling” or “coupled” refers to any connection, link, or similar relationship, and “optical coupling” or “optical coupled” refers to the relationship in which light is transmitted (impart) from one element to another element. Unless otherwise stated, elements that are coupled or coupling to each other do not have to be directly connected to each other and may be separated by intervening elements.

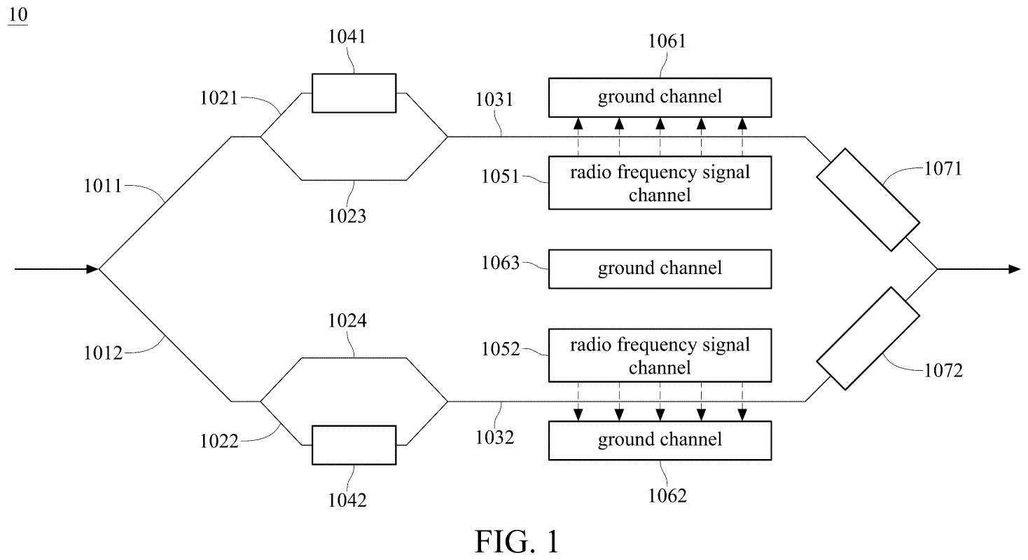

Please refer to FIG. 1 which shows an optical modulator based on a dual parallel modulation architecture according to an embodiment of the present disclosure. As shown in FIG. 1, the optical modulator 10 may include a first optical waveguide, a second optical waveguide, a first thermal electrode 1041, a second thermal electrode 1042, two radio frequency signal channels 1051, 1052 and two ground channels 1061, 1062. The first optical waveguide includes a first input section 1011, a first pre-modulation section and a first post-modulation section 1031, and the first pre-modulation section includes two first branches 1021, 1023. The second optical waveguide includes a second input section 1012, a second pre-modulation section and a second post-modulation section 1032, and the second pre-modulation section includes two second branches 1022, 1024. The first input section 1011 is optically coupled to the second input section 1012, and the first post-modulation section 1031 is optically coupled to the second post-modulation section 1032. The first thermal electrode 1041 is disposed at one of the two first branches 1021, 1023. The second thermal electrode 1042 is disposed at one of the two second branches 1022, 1024. The two radio frequency signal channels 1051, 1052 are disposed at one side of the first post-modulation section 1031 and one side of the second post-modulation section 1032, respectively. The two ground channels 1061, 1062 are disposed at the other side of the first post-modulation section 1031 and the other side of the second post-modulation section 1032, respectively.

According to one embodiment, the first optical waveguide and the second optical waveguide are optically coupled in parallel. The optical coupling may be achieved through splitting/combining elements, such as fiber optic splitters/combiners. According to one embodiment, the material of the first optical waveguide and the second optical waveguide may be lithium niobate (LiNbOx) crystal. In configuration, the first optical waveguide and the second optical waveguide may be divided into an input section, a pre-modulation section and a post-modulation section. The optical signal may be input from an optical fiber through a splitting element into the first input section 1011 and the second input section 1012 of the two optical waveguides, then the optical signal goes through two-stages modulation of the pre-modulation section and the post-modulation section to compensate for the dispersion experienced by the optical signal during the transmission process, so that the transmission distance may be farther. As an electro-optical material with excellent performance, lithium niobate has the characteristics of high speed, high extinction ratio, low chirp, etc., and is very suitable for building high-performance optical modulators.

As shown in FIG. 1, the optical modulator 10 may be a DPMZM in this embodiment. The optical modulator 10 based on DPMZM structure includes a symmetrical structure with two arms (branches), the optical configuration of one arm of the optical modulator 10 is described in detail below, and the repeated description of the optical configuration of the other arm is appropriately simplified. According to one embodiment, the first input section 1011 is divided into two first branches 1021 and 1023 through the light splitting element, and the two first branches 1021 and 1023 converge through the light combining element. Here, the two first branches 1021 and 1023 may be referred to as the pre-modulation section, and the two first branches 1021 and 1023 are coupled to the post-modulation section 1031 after being combined. According to one embodiment, the first branch 1021 is provided with a first thermal electrode 1041. Based on the sensitivity of the optical properties (e.g., refractive index) of the material of the first branch 1021 to temperature, as the voltage is applied to the first thermal electrode 1041 and the temperature rises, there may be a phase difference between the optical signals in the two first branches 1021 and 1023, which causes a change in the output optical power of the two first branches 1021 and 1023 after the combination.

According to one embodiment, a voltage range of a first DC voltage applied to the first thermal electrode 1041 and a second DC voltage applied to the second thermal electrode 1042 may be between 0.5 volts and 2.5 volts. The voltage values of the first DC voltage and the second DC voltage may be determined according to the transmission distance of the optical signal. For example, the greater the voltage values of the first DC voltage and the second DC voltage are, the more dispersion compensation values may be generated, which may correspond to longer transmission distance. According to an embodiment, the first DC voltage applied to the first thermal electrode 1041 and the second DC voltage applied to the second thermal electrode 1042 may be different. In one embodiment, as the transmission distance increases, the difference between the first DC voltage applied to the first thermal electrode 1041 and the second DC voltage applied to the second thermal electrode 1042 may be greater to generate more dispersion compensation value. Alternatively, if the dispersion compensation value is already adequate, the first DC voltage applied to the first thermal electrode 1041 and the second DC voltage applied to the second thermal electrode 1042 may also be the same, and the present disclosure is not limited thereto.

In the first post-modulation section 1031, the radio frequency signal channel 1051 and the ground channel 1061 may modulate the optical signal. Based on the electro-optic effect of the optical waveguide, the radio frequency signal channel 1051 may load the information of the applied radio frequency signal into the optical signal of the first post-modulation section 1031. According to one embodiment, two differential signals may be applied to the radio frequency signal channels 1051 and 1052, so that the phase and amplitude of the optical signal in the first post-modulation section 1031 and the second post-modulation section 1032 are modulated, thereby achieving the dispersion compensation of the second stage. According to one embodiment, the optical modulator 10 may include a plurality of radio frequency signal channels and a plurality of ground channels, and the radio frequency signal channels and the ground channels may be arranged in an alternating way with each other. As shown in FIG. 1, in one embodiment, the optical modulator 10 may further include a ground channel 1063. The ground channel 1063 may be disposed between two radio frequency signal channels 1051 and 1052 to avoid signal interference between the two radio frequency signal channels 1051 and 1052.

According to one embodiment, the optical modulator 10 may further include a third thermal electrode 1071 and/or a fourth thermal electrode 1072. The third thermal electrode 1071 is disposed at the first post-modulation section 1031 of the first optical waveguide, and the fourth thermal electrode 1072 is disposed at the second post-modulation section 1032 of the second optical waveguide. The working principles of the third thermal electrode 1071 and the fourth thermal electrode 1072 are basically the same as those of the first thermal electrode 1041 and the second thermal electrode 1042, and repeated descriptions are omitted herein. In the first post-modulation section 1031, after the optical signal is modulated by the radio frequency signal channel 1051 and the ground channel 1061, the optical signal may be modulated by the third thermal electrode 1071 to generate a phase change. In the second post-modulation section 1032, after the optical signal is modulated by the radio frequency signal channel 1052 and the ground channel 1062, the optical signal may be modulated by the fourth thermal electrode 1072 to generate a phase change. Then, the optical signals from the two arms converge and interfere, and are transmitted through the optical fiber to a distal optical receiving device. The optical receiving device may receive and process the transmitted optical signal, and analyze the information of the original radio frequency signal to realize long-distance optical communication operations.

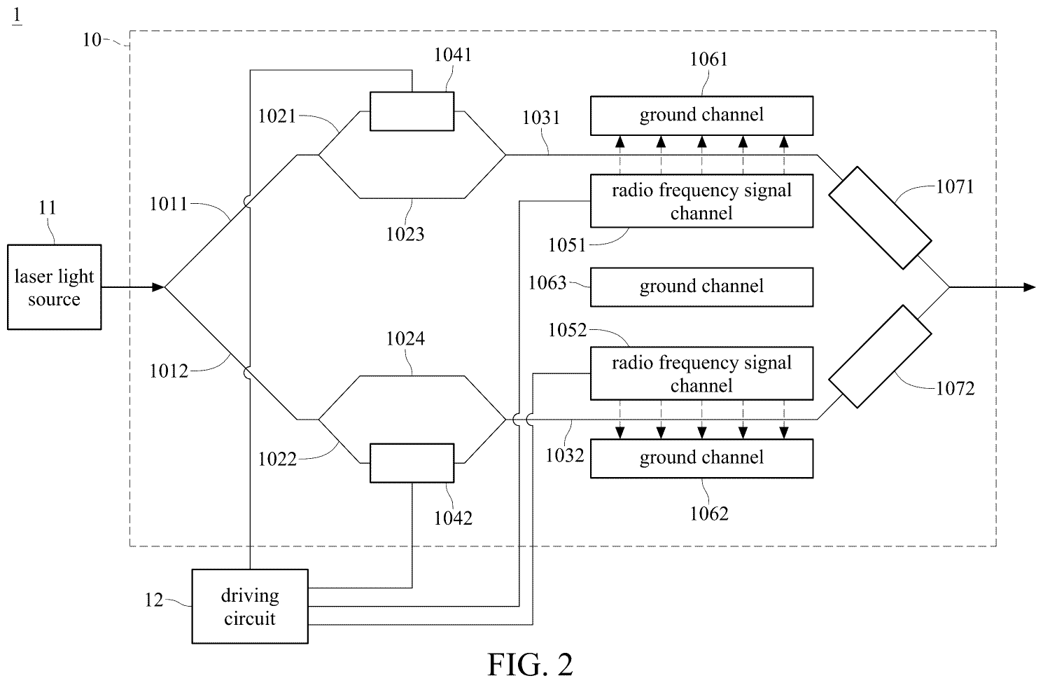

Please refer to FIG. 2 along with FIG. 1, FIG. 2 shows an optical transmission system based on a dual parallel modulation architecture according to an embodiment of the present disclosure. As shown in FIG. 2, the optical transmission system 1 may include a laser light source 11, an optical modulator 10 and a driving circuit 12. The laser light source 11 is configured to output an initial optical signal. The optical modulator 10 includes a first optical waveguide, a second optical waveguide, a first thermal electrode 1041, a second thermal electrode 1042, two radio frequency signal channels 1051, 1052 and two ground channels 1061, 1062. The first optical waveguide includes a first input section 1011, a first pre-modulation section and a first post-modulation section 1031, and the first pre-modulation section includes two first branches 1021, 1023. The second optical waveguide includes a second input section 1012, a second pre-modulation section and a second post-modulation section 1032, and the second pre-modulation section includes two second branches 1022, 1024. The first input section 1011 is optically coupled to the second input section 1012, and the first post-modulation section 1031 is optically coupled to the second post-modulation section 1032. The first thermal electrode 1041 is disposed at one of the two first branches 1021, 1023. The second thermal electrode 1042 is disposed at one of the two second branches 1022, 1024. The two radio frequency signal channels 1051, 1052 are disposed at one side of the first post-modulation section 1031 and one side of the second post-modulation section 1032, respectively. The two ground channels 1061, 1062 are disposed at the other side of the first post-modulation section 1031 and the other side of the second post-modulation section 1032, respectively. The driving circuit 12 is electrically connected to the two radio frequency signal channels 1051, 1052, and the driving circuit 12 is configured to provide two differential signals to the two radio frequency signal channels 1051, 1052.

In this embodiment, the structure of the optical modulator 10 is basically the same as that of the embodiment in FIG. 1, and repeated description is omitted herein. According to one embodiment, the laser light source 11 may emit a continuous wave optical signal or a pulse optical signal. That is, the laser light source 11 may be a continuous wave laser (CW laser) or a pulse laser. According to one embodiment, the two differential signals applied to the radio frequency signal channels 1051 and 1052 may be provided by the driving circuit 12. In one embodiment, the driving circuit 12 may be further electrically connected to the first thermal electrode 1041 and the second thermal electrode 1042, and is configured to apply a first DC voltage to the first thermal electrode 1041 and apply a second DC voltage to the second thermal electrode 1042. According to one embodiment, the driving circuit 12 may determine the voltage values of the first DC voltage and the second DC voltage according to the transmission distance of the optical signal. For example, the greater the voltage values of the first DC voltage and the second DC voltage are, the more dispersion compensation values may be generated, which may correspond to longer transmission distance. In one embodiment, as the transmission distance increases, the driving circuit 12 may determine that the difference between the first DC voltage and the second DC voltage becomes larger to generate more dispersion compensation values.

The settings of the first DC voltage, the second DC voltage and the differential signal described above may be realized through the microcontroller of the driving circuit 12 itself, or may be generated through human operation settings. In one embodiment, the driving circuit 12 may include one or more processing/control units with data receiving, recording, computing, storage and output functions. The processing/control unit is, for example, a microcontroller, a central processing unit, a graphics processor, a programmable logic controller, or any combination of the above.

In view of the above description, the optical modulator and the optical transmission system of the present disclosure are configured such that the thermal electrode is disposed at the branch of the pre-modulation section, and the radio frequency signal channel is disposed at the post-modulation section of the two optical waveguides. In this way, the phase of the optical signal of the pre-modulation section may be changed by controlling the DC voltage applied to the thermal electrode, to change the output optical power of the two branches and achieve the dispersion compensation of the first stage; and the output amplitude of the optical signal may be changed by controlling the differential signal applied to the radio frequency signal channel in the post-modulation section and achieve the dispersion compensation of the second stage. This enables the overall optical modulator and optical transmission system to have a longer transmission distance, and is especially applicable for long-distance, high-speed optical fiber communication systems.

What is claimed is:

1. An optical modulator, comprising:
a first optical waveguide comprising a first input section, a first pre-modulation section and a first post-modulation section, and the first pre-modulation section comprising two first branches;
a second optical waveguide comprising a second input section, a second pre-modulation section and a second post-modulation section, and the second pre-modulation section comprising two second branches, wherein the first input section is optically coupled to the second input section, and the first post-modulation section is optically coupled to the second post-modulation section;
a first thermal electrode disposed at one of the two first branches;
two radio frequency signal channels disposed at one side of the first post-modulation section and one side of the second post-modulation section, respectively; and
two ground channels disposed at the other side of the first post-modulation section and the other side of the second post-modulation section, respectively.

2. The optical modulator of claim 1, wherein a material of the first optical waveguide and the second optical waveguide is a lithium niobate crystal.

3. The optical modulator of claim 1, further comprising:
a second thermal electrode, disposed at one of the two second branches.

4. The optical modulator of claim 3, further comprising:
a third thermal electrode, disposed at the first post-modulation section of the first optical waveguide; and
a fourth thermal electrode, disposed at the second post-modulation section of the second optical waveguide.

5. The optical modulator of claim 3, wherein a voltage range of a first DC voltage applied to the first thermal electrode and a second DC voltage applied to the second thermal electrode is between 0.5 volts and 2.5 volts.

6. The optical modulator of claim 3, wherein a first DC voltage applied to the first thermal electrode and a second DC voltage applied to the second thermal electrode are different.

7. The optical modulator of claim 1, further comprising another ground channel disposed between the two radio frequency signal channels.

8. The optical modulator of claim 1, wherein the optical modulator is a dual-parallel Mach-Zehnder modulator.

9. An optical transmission system, comprising:
a laser light source configured to output an initial optical signal;
an optical modulator, comprising:
a first optical waveguide comprising a first input section, a first pre-modulation section and a first post-modulation section, and the first pre-modulation section comprising two first branches, wherein the first input section is optically coupled to the laser light source;
a second optical waveguide comprising a second input section, a second pre-modulation section and a second post-modulation section, and the second pre-modulation section comprising two second branches, wherein the second input section is optically coupled to the laser light source, the first input section is optically coupled to the second input section, and the first post-modulation section is optically coupled to the second post-modulation section;
a first thermal electrode disposed at one of the two first branches;
two radio frequency signal channels disposed at one side of the first post-modulation section and one side of the second post-modulation section, respectively; and
two ground channels disposed at the other side of the first post-modulation section and the other side of the second post-modulation section, respectively; and
a driving circuit electrically connected to the two radio frequency signal channels, wherein the driving circuit is configured to provide two differential signals to the two radio frequency signal channels.

10. The optical transmission system of claim 9, wherein a material of the first optical waveguide and the second optical waveguide is a lithium niobate crystal.

11. The optical transmission system of claim 9, wherein the optical modulator further comprises:
a second thermal electrode, disposed at one of the two second branches.

12. The optical transmission system of claim 11, wherein the optical modulator further comprises:
a third thermal electrode, disposed at the first post-modulation section of the first optical waveguide; and
a fourth thermal electrode, disposed at the second post-modulation section of the second optical waveguide.

13. The optical transmission system of claim 11, wherein the driving circuit is further electrically connected to the first thermal electrode and the second thermal electrode, and is configured to apply a first DC voltage to the first thermal electrode and apply a second DC voltage to the second thermal electrode.

14. The optical transmission system of claim 13, wherein a voltage range of the first DC voltage and the second DC voltage is between 0.5 volts and 2.5 volts.

15. The optical transmission system of claim 13, wherein the first DC voltage and the second DC voltage are different.

16. The optical transmission system of claim 9, wherein the optical modulator further comprises another ground channel disposed between the two radio frequency signal channels.
